(19) United States
(12) Patent Application Publication
(10) Pub. No.: US 2020/0313484 A1
(43) Pub. Date: Oct. 1, 2020

(54) ROTATING ELECTRICAL MACHINE

(71) Applicant: AISIN SEIKI KABUSHIKI KAISHA, Kariya-shi (JP)

(72) Inventor: Kanto IWASE, Kariya-shi (JP)

(73) Assignee: AISIN SEIKI KABUSHIKI KAISHA, Kariya-shi (JP)

(21) Appl. No.: 16/811,310

(22) Filed: Mar. 6, 2020

(30) Foreign Application Priority Data
Mar. 28, 2019 (JP) 2019-062476

(51) Int. Cl. H02K 1/30

(52) U.S. Cl. CPC H02K 1/30

(57) ABSTRACT

A rotating electrical machine includes a rotor and a stator. The rotor includes a shaft, and a rotor core including a shaft press fit hole and plural magnetic steel sheets. Each magnetic steel sheet includes plural press fit protrusions provided to protrude towards the shaft. The press fit protrusions are in contact with the shaft. Each magnetic steel sheet includes plural guide protrusions provided to protrude towards the shaft. The guide protrusions guide the shaft press fitted into the shaft press fit hole. The magnetic steel sheets are stacked to be shifted in a circumferential direction so that the press fit protrusions and the guide protrusions overlap each other in an axial direction.

### CROSS REFERENCE TO RELATED APPLICATIONS

This application is based on and claims priority under 35 U.S.C. § 119 to Japanese Patent Application 2019-062476, filed on Mar. 28, 2019, the entire content of which is incorporated herein by reference.

### TECHNICAL FIELD

This disclosure generally relates to a rotating electrical machine.

### BACKGROUND DISCUSSION

A known rotating electrical machine provided with a rotor core including stacked plural magnetic steel sheets is known (for example, JP2000-270505A which will be hereinafter referred to as Patent reference 1).

Patent reference 1 discloses a stepping motor (a rotating electrical machine) provided with a core (a rotor core) including stacked plural metal plates (plural magnetic steel sheets). The stepping motor includes a shaft. A central portion of the core includes a hole formed to penetrate a central portion of each of the plural metal plates. The shaft is press fitted in the hole penetrating the plural metal plates, and thus is fixed relative to the core.

According to the Patent reference 1, an inner circumferential portion of the plural metal plates, the inner circumferential portion which is positioned at a shaft side, is provided with plural cut-outs. The inner circumferential portion of the plural metal plates, the inner circumferential portion which is positioned at the shaft side, is also provided with press-fit interference or press-fit allowance (a press fit protruding portion) bent by the shaft when the shaft is press fitted, the press-fit interference is formed at other portion than the plural cut-outs. At each of the plural metal plate, the plural cut-outs are arranged on a straight line in a direction in which the shaft extends. At each of the plural metal plates, the plural press-fit interferences corresponding to other portion than the plural cut-outs are arranged on a straight line in the direction in which the shaft extends.

The metal plates of Patent reference 1 include the same number of the plural cut-outs to each other and the same number of the plural press-fit interference portions to each other, and accordingly, the metal plates are formed with the use of a common press die. Accordingly, unlike a case in which plural press dice are prepared for forming plural metal plates, the plural metal plates are formed in the same process. Consequently, productivity of the stepping motor is enhanced.

At the known stepping motor of the Patent reference 1, however, the press fit interferences of the respective plural metal plates are adjacent to each other in an axial direction of the shaft. Thus, the known stepping motor of the Patent reference 1 includes an inconvenience that a press fitting load at the press fitting of the shaft into the hole penetrating the plural metal plates is increased because each of the press fit interferences of the plural metal plates is not easily bent at the press-fitting of the shaft, while the productivity of the stepping motor is enhanced since the plural metal plates are formed with the use of the common press die. Accordingly, at the stepping motor of Patent reference 1, there arises a problem that it is difficult to achieve both a reduction in the press fitting load at the press-fitting of the shaft and the enhancement of the productivity of the stepping motor (the rotating electrical machine).

A need thus exists for a rotating electrical machine which is not susceptible to the drawback mentioned above.

### SUMMARY

According to an aspect of this disclosure, a rotating electrical machine includes a rotor, and a stator provided to oppose the rotor in a radial direction. The rotor includes a shaft, and a rotor core including a shaft press fit hole in which the shaft is configured to be press fitted and a plurality of magnetic steel sheets stacked in an axial direction of the shaft. Each of the plurality of magnetic steel sheets includes a plurality of press fit protrusions provided at an inner circumferential portion of the magnetic steel sheet to protrude towards the shaft. The plurality of press fit protrusions is in contact with the shaft press fitted in the shaft press fit hole. Each of the plurality of magnetic steel sheets includes a plurality of guide protrusions provided at the inner circumferential portion of the magnetic steel sheet to protrude towards the shaft with protruding amount which is smaller than protruding amount of the plurality of press fit protrusions. The plurality of guide protrusions guides the shaft being press fitted into the shaft press fit hole. The plurality of magnetic steel sheets includes the adjacent magnetic steel sheets which are adjacent to each other in the axial direction of the shaft, and the adjacent magnetic steel sheets includes the magnetic steel sheet at a first side in the axial direction and the magnetic steel sheet at a second side in the axial direction. The plurality of magnetic steel sheets is stacked to be shifted relative to each other in a circumferential direction so that the press fit protrusions of the magnetic steel sheet at the first side and the guide protrusions of the magnetic steel sheet at the second side overlap each other in the axial direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a rotating electrical machine of an embodiment disclosed here;

FIG. 2 is a cross-sectional view o taken along II-II in FIG. 1;

FIG. 3 is a perspective view of a rotor core of the rotating electrical machine of the embodiment;

FIG. 4 is a plan view of the rotor core of the rotating electrical machine of the embodiment;

FIG. 5 is an enlarged view of a portion Z of FIG. 4;

FIG. 6 is a schematic view illustrating guide protrusions before a shaft is press fitted, according to the rotating electrical machine of the embodiment;

FIG. 7 is a schematic view illustrating press fit protrusions before the shaft is press fitted, according to the rotating electrical machine of the embodiment;

FIG. 8 is a schematic developed view of stacked magnetic steel sheets, from a portion E of FIG. 5;

FIG. 9 a cross-sectional view taken along IX-IX in FIG. 5;

FIG. 10 is a schematic view illustrating a stacked structure of the plural magnetic steel sheets according to a first variation of the embodiment disclosed here; and

FIG. 11 s a schematic view illustrating a stacked structure of the plural magnetic steel sheets according to a second variation of the embodiment disclosed here.

### DETAILED DESCRIPTION

An embodiment disclosed here will be explained hereunder with the reference to the drawings.

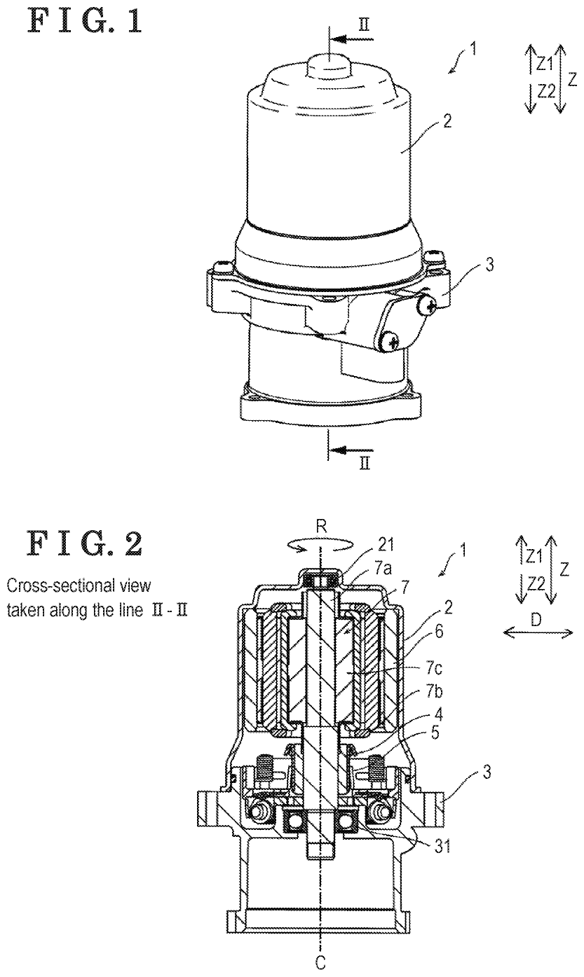

A structure of a rotating electrical machine 1 of the embodiment will be explained with the reference to FIGS. 1 to 9.

The rotating electrical machine 1 is configured as a motor, for example. Specifically, the rotating electrical machine 1 is configured as a motor for a compressor configuring part of an air suspension apparatus of a vehicle (an automobile) or a motor for a hydro booster configuring part of a brake apparatus of a vehicle (an automobile), for example.

As illustrated in FIGS. 1 and 2, the rotating electrical machine 1 includes a motor case 2, a housing 3, a commutator 4, a brush 5, a stator 6, and a rotor 7 including a shaft 7a.

In the explanation hereafter, an axial direction of the shaft 7a corresponds to a Z direction. The Z direction includes a Z1 direction towards a side of the motor case 2, and a Z2 direction towards a side of the housing 3. A circumferential direction of the shaft 7a corresponds to an R direction. A radial direction of the shaft 7a corresponds to a D direction.

As illustrated in FIG. 2, the motor case 2 covers the stator 6 and the rotor 7 from the Z1 direction-side. The housing 3 covers the stator 6 and the rotor 7 from the Z2 direction-side. The motor case 2 is attached to the housing 3 with a fastening member. The commutator 4 is fixed to a portion of the shaft 7a, the portion which is at the Z2 direction-side. The brush 5 is fixed to the housing 3. The commutator 4 and the brush 5 are in contact with each other. The brush 5 is configured to obtain electric power from outside and to supply the obtained electric power to the commutator 4.

The stator 6 is configured to generate a magnetic force for rotating the rotor 7 and the shaft 7a. The stator 6 includes a permanent magnet, for example. The stator 6 is fixed to an inner surface of the motor case 2. The stator 6 opposes the rotor 7 in the D direction. The rotating electrical machine 1 is configured as a motor of an inner rotor type.

The rotor 7 is configured to rotate integrally with the shaft 7a due to a magnetic force generated at the rotor 7 and the magnetic force of the stator 6. Specifically, the rotor 7 includes the shaft 7a, a coil 7b and a rotor core 7c.

The shaft 7a is configured to be rotatable about a rotational axis line C extended in the Z direction. The shaft 7a is supported by a bearing portion 21 and another bearing portion 31. The bearing portion 21 and the bearing portion 31 are fixed to the motor case 2 and the housing 3, respectively. The coil 7b is wound on the rotor core 7c. The coil 7b is configured to generate the magnetic force upon being supplied with the electric power.

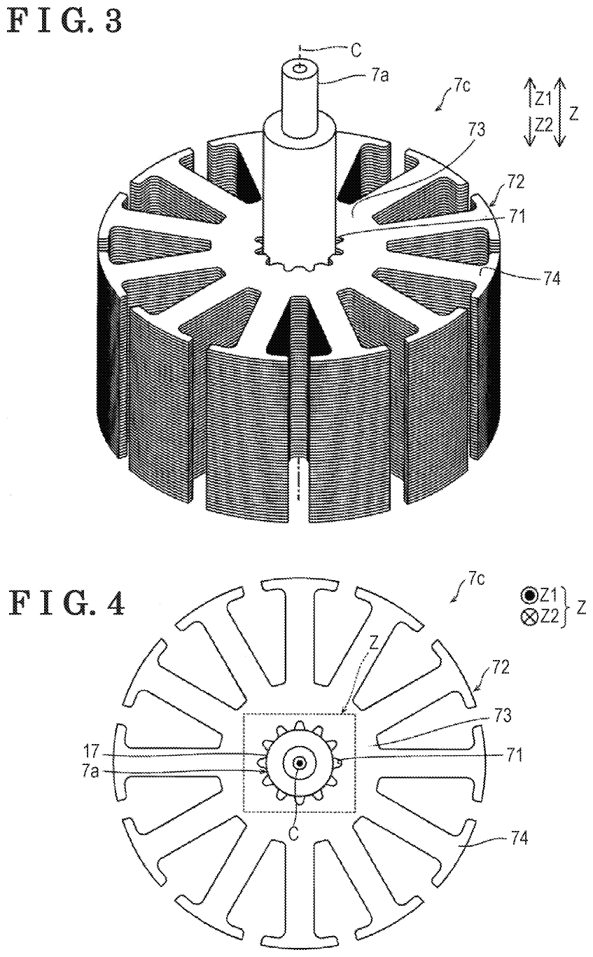

As illustrated in FIGS. 3 and 4, a shaft press fit hole 71, into which the shaft 7a is to be press fitted, is formed at the rotor core 7c. The rotor core 7c includes plural magnetic steel sheets 72 stacked or laminated along the Z direction.

Each of the plural magnetic steel sheets or magnetic steel plates 72 includes a base portion 73 and plural protruding pole portions 74. The base portion 73 is provided at each of the plural magnetic steel sheets 72 to be positioned at a side of the rotational axis line C in a direction which is orthogonal to the Z direction. The base portion 73 includes the shaft press fit hole 71 formed at a central portion of the base portion 73 in a direction which is orthogonal to the Z direction. The shaft press fit hole 71 is formed to penetrate through each of the plural magnetic steel sheets 72 in the Z direction. The central point of the shaft press fit hole 71 is arranged on the rotational axis line C. Each of the plural protruding pole portions 74 protrudes from an outer-side end portion of the base portion 73 to be away from the base portion 73 in a direction which is orthogonal to the Z direction.

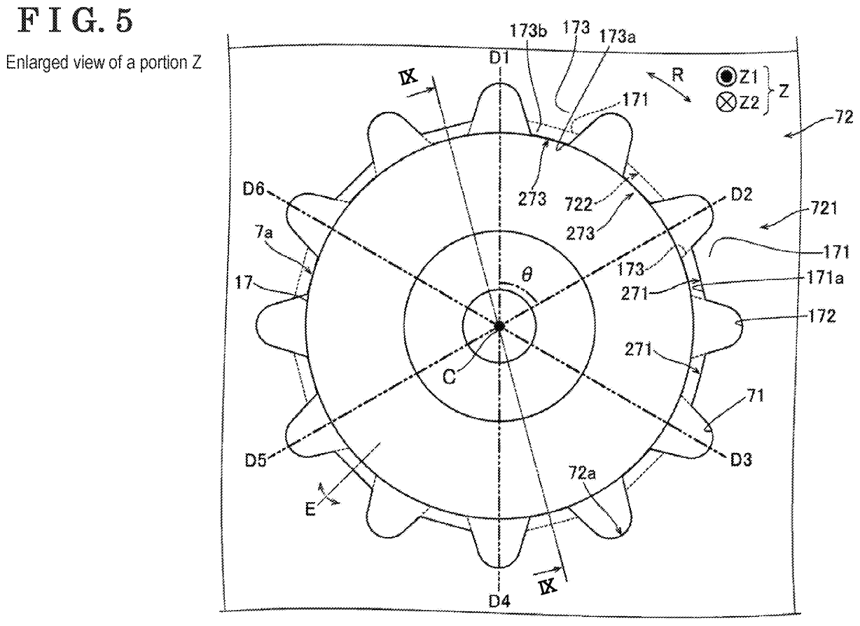

(Press fit protrusion and guide protrusion) As illustrated in FIG. 5, in the R direction, each of the plural magnetic steel sheets 72 is configured to be in contact with plural portions of an entire outer circumferential surface 17 of the shaft 7a in a dispersed manner, and not to be in contact with the entire outer circumferential surface 17.

Specifically, each of the plural magnetic steel sheets 72 of the embodiment includes plural guide protrusions 171 and plural press fit protrusions 173. Each of the plural magnetic steel sheets 72 includes a shape of petals formed of the plural guide protrusions 171 and the plural press fit protrusions 173, when viewed in the Z1 direction.

Each of the guide protrusions 171 includes a substantially trapezoid shape, wherein a width of the guide protrusion 171 in the R direction gradually increases from a tip 171a of the guide protrusion 171 towards a base (root) portion of the guide protrusion 171. In detail, a width, in the R direction, of the base (root) portion of the guide protrusion 171 is larger than a width, in the R direction, of the tip 171a.

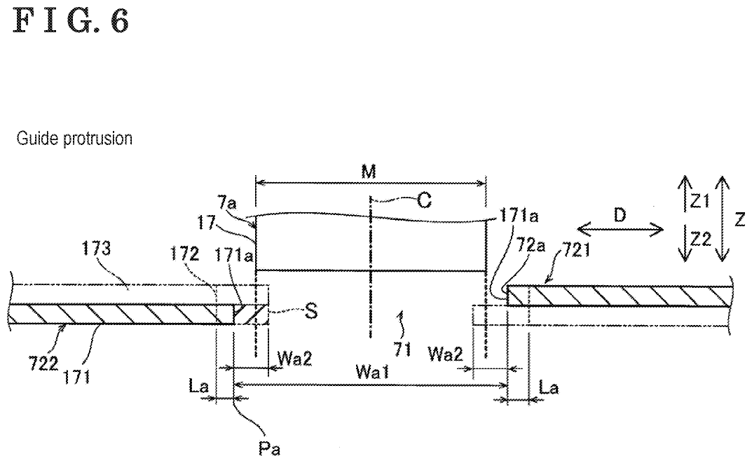

As illustrated in FIG. 6, at an inner circumferential portion 72a of the magnetic steel sheet 72, each of the plural guide protrusions 171 is configured to protrude towards the shaft 7a in such a manner that the guide protrusion 171 guides the shaft 7a that is being press-fitted into the shaft press fit hole 71 by insertion, wherein a protruding amount of the guide protrusion 171 is smaller than a protruding amount of the press fit protrusion 173. That is, the shaft 7a which becomes inclined during the press-fitting comes in contact with the plural guide protrusions 171, and thus each of the guide protrusions 171 is configured to guide the shaft 7a back into a predetermined position. The predetermined position corresponds to a position at which the central point of the shaft 7a and the central point of the shaft press fit hole 71 substantially matches or coincides with each other when viewed from the Z1 direction-side after the press fitting work.

Specifically, an inner diameter Wa1 between the tips 171a of the plural guide protrusions 171 is formed to be larger than an outer diameter M of the shaft 7a. Each of the plural guide protrusions 171 protrudes from an outermost portion 172, which is positioned outermost in the D direction, of the inner circumferential portion 72a of the magnetic steel sheet 72 towards the inner side in the D direction. Each of the plural guide protrusions 171 includes a protruding length La. The protruding length La is a length which allows a clearance to be provided between each of the plural guide protrusions 171 and the circumferential surface 17 of the shaft 7a during the press fitting operation. A guide-side space S is formed between the tip 171a of each of the guide protrusions 171 and a tip 173a of each of the press fit protrusions 173. The guide-side space S includes a length Wa2 in the D direction. Thus, each of the guide protrusions 171 is formed to include a dimensional tolerance of loose fitting relative to the shaft 7a. The inner circumferential portion 72a of the magnetic steel sheet 72 corresponds to an inner circumferential surface, which faces towards the shaft press fit hole 71, of the magnetic steel sheet 72.

As described above, each of the guide protrusions 171 is configured not to act as resistance against the press fitting of the shaft 7a during the press fitting work. Each of the guide protrusions 171 is not configured to fix an arrangement position of the shaft 7a after the shaft 7a is press fitted.

As illustrated in FIG. 5, each of the press fit protrusions 173 includes a substantially trapezoid shape, wherein a width of the press fit protrusion 173 in the R direction gradually increases from the tip 173a towards a base (root) portion of the press fit protrusion 173. In detail, a width, in the R direction, of the base (root) portion of the press fit protrusion 173 is larger than a width, in the R direction, of the tip 173a of the press fit protrusion 173.

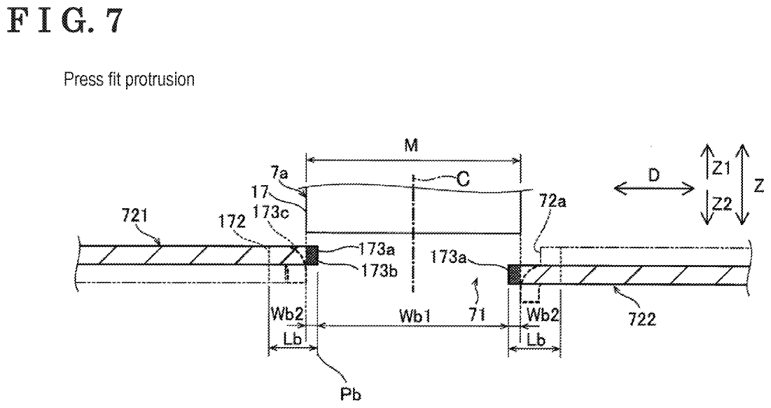

As illustrated in FIG. 7, at the inner circumferential portion 72a of the magnetic steel sheet 72, each of the plural press fit protrusions 173 protrudes towards the shaft 7a so that the press fit protrusion 173 is configured to be in contact with the shaft 7a press-fitted in the shaft press fit hole 71. That is, a tip-side portion 173c of each of the plural press fit protrusions 173 includes a portion which overlaps with the outer circumferential surface 17 of the shaft 7a when viewed from the Z1 direction-side.

Specifically, an inner diameter Wb1 between the tips 173a of the plural press fit protrusions 173 is formed to be smaller than the outer diameter M of the shaft 7a before the press-fitting. Each of the plural press fit protrusions 173 protrudes from the outermost portion 172, which is positioned outermost in the D direction, of the inner circumferential portion 72a of the magnetic steel sheet 72 towards the inner side in the D direction. Each of the plural press fit protrusions 173 includes a protruding length Lb. The protruding length Lb is a length which allows the shaft 7a to press or push each of the plural press fit protrusions 173 at the press fitting. Each of the plural press fit protrusions 173 includes an overlapping portion 173b arranged at an inner side in the D direction relative to the outer circumferential surface 17 of the shaft 7a before the press fitting. The overlapping portion 173b corresponds to a part of the press fit protrusion 173, the part which is arranged from a tip position Pb of the press fit protrusion 173 to an outward position by a length Wb2 in the D direction.

The tip-side portion 173c of each of the plural press fit protrusions 173 keeps the state in which the tip-side portion 173c is in contact with the outer circumferential surface 17 of the shaft 7a after the press fitting. That is, each of the plural press fit protrusions 173 is configured to fix or secure the arrangement position of the shaft 7a after the press fitting.

Specifically, the tip-side portion 173c of each of the plural press fit protrusions 173 is bent by the shaft 7a towards the Z2 direction-side during the press fitting. Then, in the state where the tip-side portions 173c are bent, the tip-side portions 173c hold therebetween the shaft 7a in a sandwiching manner after the press fitting. In this state, the tip-side portion 173c of each of the plural press fit protrusions 173 pushes the shaft 7a towards the rotational axis line C. Thus, after the press fitting, each of the plural press fit protrusions 173 retains the shaft 7a in a state where the press fit protrusions 173 fix or secure the arrangement position of the shaft 7a. As described above, each of the plural press fit protrusions 173 is formed to include a dimensional tolerance of interference fitting (a tight fitting) relative to the shaft 7a.

As illustrated in FIGS. 6 and 7, the tip position Pb of the press fit protrusion 173 is positioned at an inner side relative to a tip position Pa of the guide protrusion 171 in the D direction. That is, a portion of the press fit protrusion 173, the portion which is positioned at an inner side relative to the tip position Pa of the guide protrusion 171, is arranged in the guide-side space S to be positioned at the Z1 direction-side. The guide-side space S functions as a space portion which allows deformation of the tip-side portions 173c of the press fit protrusions 173 that are pressed or pushed by the shaft 7a towards the Z2 direction-side at the press fitting operation. In detail, the guide-side space S is a space portion allowing the tip-side portions 173c of the press fit protrusions 173, which are pressed towards the Z2 direction-side by the shaft 7a at the press fitting, to escape towards the Z2 direction-side. Thus, the tip-side portions 173c of the press fit protrusions 173 are bent towards the Z2 direction side due to the press-fitting of the shaft 7a.

(Press fit protrusion group and guide protrusion group) As illustrated in FIG. 5, the plural press fit protrusions 173 are arranged in a manner that plural (two, for example) of the press fit protrusions 173 are adjacent to each other in the R direction. The plural guide protrusions 171 are arranged in a manner that plural (two, for example) of the guide protrusions 171 are adjacent to each other in the R direction. The plural press fit protrusions 173 which are adjacent to each other in the R direction correspond to a press fit protrusion group 273 and the plural guide protrusions 171 which are adjacent to each other in the R direction correspond to a guide protrusion group 271. The guide protrusion group 271 is an example of a set of plural guide protrusions of the disclosure and the press fit protrusion group 273 is an example of a set of plural press fit protrusions of the disclosure.

In the embodiment, the press fit protrusion group 273 and the guide protrusion group 271 are arranged to be adjacent to each other in the R direction. In detail, in the embodiment, the press fit protrusion groups 273 and the guide protrusion groups 271 are arranged to alternate with each other along an entire circumference of the inner circumferential portion 72a of the magnetic steel sheet 72.

The press fit protrusion groups 273 and the guide protrusion groups 271 are arranged along the inner circumferential portion 72a of the magnetic steel sheet 72 at an equal angular interval (at a predetermined angle θ interval). In the embodiment, three (3 sets) of the press fit protrusion groups 273 are provided along the inner circumferential portion 72a of the magnetic steel sheet 72, and accordingly six of the press fit protrusions 173 are arranged at the inner circumferential portion 72a of the magnetic steel sheet 72. Three (3 sets) of the guide protrusion groups 271 are provided along the inner circumferential portion 72a of the magnetic steel sheet 72, and accordingly six of the guide protrusions 171 are arranged at the inner circumferential portion 72a of the magnetic steel sheet 72. Thus, twelve of the press fit protrusions 173 and the guide protrusions 171 are arranged at the inner circumferential portion 72a of the magnetic steel sheet 72 in total. Consequently, the press fit protrusions 173 and the guide protrusions 171 are arranged at every approximately 30 degrees. That is, the press fit protrusion groups 273 and the guide protrusion groups 271 are arranged alternately at every approximately 60 degrees.

Thus, each of the plural press fit protrusion groups 273 is arranged in a section formed by dividing the inner circumferential portion 72a of the magnetic steel sheet 72 by the predetermined angle θ (substantially 60 degrees). Specifically, the plural press fit protrusion groups 273 are respectively arranged between a first position D1 and a second position D2, between a third position D3 and a fourth position D4, and between a fifth position D5 and a sixth position D6, of the inner circumferential portion 72a of the magnetic steel sheet 72.

In a similar manner, each of the plural guide protrusion groups 271 is arranged in a section formed by dividing the inner circumferential portion 72a of the magnetic steel sheet 72 by the predetermined angle θ (substantially 60 degrees). Specifically, the plural guide protrusion groups 271 are respectively arranged between the second position D2 and the third position D3, between the fourth position D4 and the fifth position D5, and between the sixth position D6 and the first position D1, of the inner circumferential portion 72a of the magnetic steel sheet 72.

Each of the first position D1, the second position D2, the third position D3, the fourth position D4, the fifth position D5 and the sixth position D6 is formed by dividing the inner circumferential portion 72a of the magnetic steel sheet 72 into the predetermined angle θ (substantially 60 degrees).

(Arrangement of the press fit protrusion and guide protrusion) As illustrated in FIG. 5, each of the magnetic steel sheets 72 is configured to be in contact with the circumferential surface 17 of the shaft 7a, in the dispersed manner in the D direction.

Specifically, each of the press fit protrusion groups 273 and each of the guide protrusion groups 271 are arranged side by side with each other in the R direction, and at the same time, are arranged to be point symmetric with each other with respect to the central point of the shaft 7a when viewed from the Z1 direction-side. That is, a contact area where the magnetic steel sheet 72 and the shaft 7a are in contact with each other decreases (or changes) not only in the R direction but also in a direction which is orthogonal to the Z direction. The central point of the shaft 7a corresponds to a position of the rotational axis line C when the shaft 7a is viewed from the Z1 direction-side.

In the Z direction, each of the plural magnetic steel sheets 72 of the embodiment is configured to be in contact with the plural portions of the circumferential surface 17 of the shaft 7a in the dispersed manner instead of being in contact with over the entire circumferential surface 17.

Specifically, the adjacent magnetic steel sheets 72 which are adjacent to each other in the Z direction include a magnetic steel sheet 721 arranged at the Z1 direction-side and a magnetic steel sheet 722 arranged at the Z2. The press fit protrusions 173 of the magnetic steel sheet 721 arranged at the Z1 direction-side and the guide protrusions 171 of the magnetic steel sheet 722 arranged at the Z2 direction-side are adjacent to each other in the Z direction. That is, the magnetic steel sheet 721 at the Z1 direction-side and the magnetic steel sheet 722 at the Z2 direction side, both of which are included in the adjacent magnetic steel sheets 72 in the Z direction, are stacked to be shifted relative to each other in the R direction (rotationally stacked or built up), such that the press fit protrusion 173 of the magnetic steel sheet 721 at the Z1 direction-side and the guide protrusion 171 of the magnetic steel sheet 722 at the Z2 direction-side (that is indicated with the dotted line in the drawing) are overlapped each other in the Z direction. The magnetic steel sheet 721 arranged at the Z1 direction-side is an example of “a magnetic steel sheet at a first side” of the disclosure. The magnetic steel sheet 722 arranged at the Z2 direction-side is an example of “a magnetic steel sheet at a second side” of the disclosure.

In detail, out of the adjacent magnetic steel sheets 72, the press fit protrusion 173 of the magnetic steel sheet 721 arranged at the Z1 direction-side is stacked (rotationally stacked) to be shifted or displaced in the R direction by the predetermined angle θ (substantially 60 degrees) relative to the guide protrusion 171 of the magnetic steel sheet 722 arranged at the Z2 direction-side. That is, the press fit protrusions 173 of the magnetic steel sheet 721 at the Z1 direction-side are stacked so as to correspond to the arrangement positions of the guide protrusions 171 of the magnetic steel sheet 722 at the Z2 direction-side.

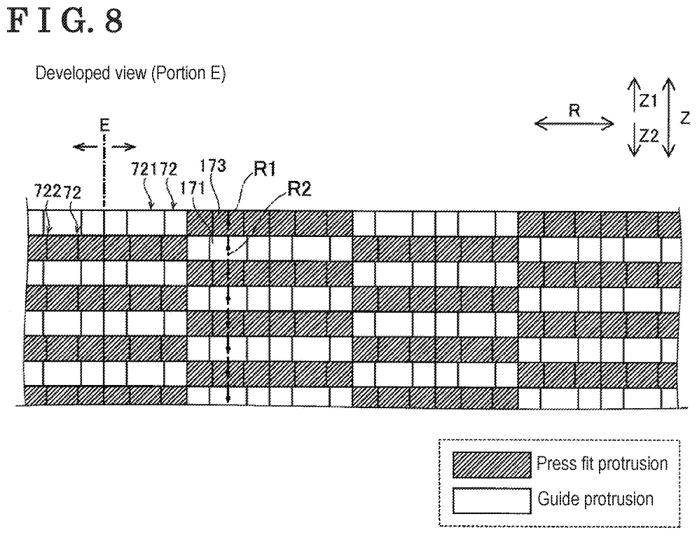

As described above and illustrated in FIG. 8, at the plural magnetic steel sheets 72, the press fit protrusions 173 and the guide protrusions 171 are arranged to be alternated with each other in the Z direction. In detail, regarding the adjacent magnetic steel sheets 72, the press fit protrusion 173 of the magnetic steel sheet 721 at the Z1 direction-side includes a center line R1 in the R direction, and the guide protrusion 171 of the magnetic steel sheet 722 at the Z2 direction-side includes a center line R2 in the R direction. The magnetic steel sheet 721 at the Z1 direction-side and the magnetic steel sheet 722 at the Z2 direction-side are stacked to be shifted in the R direction relative to each other, so that the center line R1 of the press fit protrusion 173 of the magnetic steel sheet 721 and the center line R2 of the guide protrusion 171 of the magnetic steel sheet 722 are aligned with each other in the Z direction.

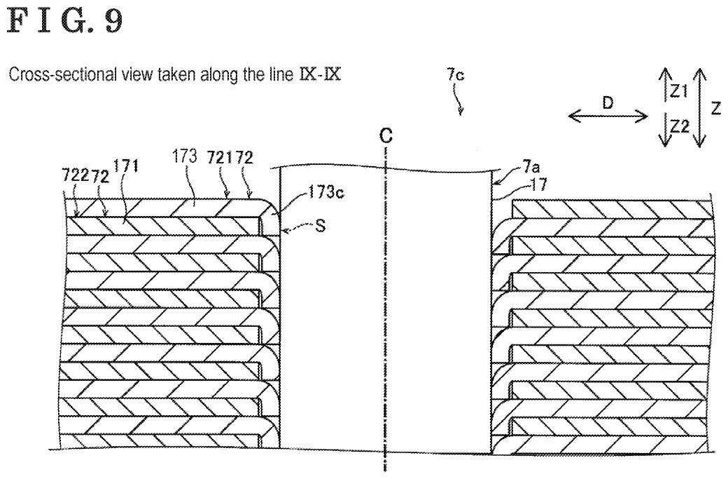

As illustrated in FIG. 9, in the Z direction, each of the plural magnetic steel sheets 72 is configured to allow a press fitting load, which is given by the shaft 7a to the press fit protrusions 173 at the press fitting of the shaft 7a, to escape. That is, by arranging the press fit protrusion 173 and the guide protrusion 171 alternately with each other in the Z direction, the plural magnetic steel sheets 72 are stacked in such a manner that the tip-side portion 173c of the press fit protrusion 173 that is pressed by the shaft 7a towards the Z2 direction-side at the press fitting operation is arranged at the Z1 direction-side in the guide-side space S.

Accordingly, when the shaft 7a is press fitted into the shaft press fit hole 71, each of the plural press fit protrusions 173 arranged in the Z direction is allowed to escape to the guide-side space S which is positioned at the Z2 direction-side. That is, the guide-side space S corresponds to a clearance or relief allowance for the press fit protrusions 173 to escape. As a result, in a state where the shaft 7a has been press fitted in the shaft press fit hole 71, each of the tip-side portions 173c of the plural press fit protrusions 173 arranged in the Z direction is bent towards the Z2 direction-side.

(Effects of the embodiment) The following effects can be obtained in the embodiment.

In the embodiment, as described above, each of the plural magnetic steel sheets 72 includes the plural press fit protrusions 173 that are in contact with the shaft 7a press fitted in the shaft press fit hole 71, and the plural guide protrusions 171 configured to guide the shaft 7a being press fitted into the shaft press fit hole 71. The Z-directionally adjacent magnetic steel sheets 72 are stacked to be shifted relative to each other in the R direction such that the press fit protrusions 173 of the magnetic steel sheet 721 arranged at the Z1 direction-side and the guide protrusions 171 of the magnetic steel sheet 722 arranged at the Z2 direction-side are overlapped each other in the Z direction. Accordingly, the guide-side space S is provided in a portion at a side of the shaft 7a relative to the tip 171a of each of the guide protrusions 171 of the magnetic steel sheet 722 arranged at the Z2 direction-side. Here, in the Z direction, the guide-side space S is formed between the circumferential surface 17 of the shaft 7a and a portion of the press fit protrusion 173 of the magnetic steel sheet 721 at the Z1 direction-side, the portion which is at a side of the shaft 7a. Accordingly, since the guide-side space S is provided, the portion, which is at a side of the shaft 7a, of the press fit protrusion 173 of the magnetic steel sheet 721 arranged at the Z1 direction-side is easily bent towards the Z2 direction-side by the press fitting load generated when the shaft 7a is press fitted into the shaft press fit hole 71. That is, the press fitting load required to press fit the shaft 7a into the shaft press fit hole 71 can be reduced compared to a case in which the guide-side space S is not provided. The plural magnetic steel sheets 72 include in common the plural press fit protrusions 137 and the plural guide protrusions 171, thus the plural magnetic steel sheets 72 can be processed with a common die. Accordingly, productivity of the rotating electrical machine 1 can be enhanced. As a result, both the reduction in the press fitting load to press fit the shaft 7a and the enhancement of the productivity of the rotating electrical machine 1 can be achieved. Even in a case where the shaft 7a is inclined or tilted during the press fitting work due to deviation or displacement of a jig used to press fit the shaft 7a, the shaft 7a comes in contact with the guide protrusions 171, and thus the shaft 7a is returned to the predetermined position. Consequently, it is restricted that the press fitting load of the shaft 7a increases due to that the shaft 7a is press fitted in the state of being tilted, and an accuracy in placing the shaft 7a in the predetermined position of the shaft press fit hole 71 is enhanced. Each of the plural magnetic steel sheets 72 is provided with the plural press fit protrusions 137 and the plural guide protrusions 171 in the common manner, thus one type of the magnetic steel sheet 72 can be used. Accordingly, an increase in types of the press or stamping dice can be restricted even though the press fit protrusions 173 and the guide protrusions 171 are formed at the magnetic steel sheets 72.

In the embodiment, the press fit protrusions 173 and the guide protrusions 171 are arranged in a manner that the press fit protrusion 173 and the guide protrusion 171 alternate with each other in the Z direction at the plural magnetic steel sheets 72. Accordingly, the guide-side space S can be arranged adjacent to the portion of each of the press fit protrusions 173 of the plural magnetic steel sheets 72, the portion which is positioned at a side of the shaft 7a. Thus, each of the plural press fit protrusions 173 is easily bent towards the Z2 direction-side by the press fitting load. As result, in the Z direction, the press fitting load needed to press-fit the shaft 7a into the shaft press fit hole 71 can be even further reduced.

In the embodiment, as described above, the magnetic steel sheet 721 at the Z1 direction-side and the magnetic steel sheet 722 at the Z2 direction-side are stacked to be shifted relative to each other in the R direction, such that the center line R1, which is the center in the R direction, of the press fit protrusion 173 of the magnetic steel sheet 721 at the Z1 direction side and the center line R2, which is the center in the R direction, of the guide protrusion 171 of the magnetic steel sheet 722 at the Z2 direction-side are aligned with each other in the Z direction. Accordingly, a positional shift, in the R direction, of the guide-side space S and the press fit protrusion 173 of the magnetic steel sheet 721 at the Z1 direction-side relative to each other is restricted from occurring, and thus the press fit protrusions 173 of the magnetic steel sheets 72 are bent more reliably due to the press fitting load of the shaft 7a. As a result, the press fitting load required at the press-fitting of the shaft 7a into the shaft fit hole 71 can be reduced even more reliably.

In the embodiment, as described above, the press fit protrusion group 273 and the guide protrusion group 271 are arranged adjacent to each other in the R direction. By providing the above-described configuration to each of the plural magnetic steel sheets 72, the advantageous effects are obtained that the press fitting load required to press fit the shaft 7a into the shaft press fit hole 71 can be reduced more and that variation or dispersion of the press fitting load of the shaft 7a can be restricted, compared to a case in which a single press fit protrusion and a single guide protrusion are arranged adjacent to each other in the R direction.

In the embodiment, as described above, the inner diameter Wb1 of the plural press fit protrusions 173 of the press fit protrusion group 273 is provided to be smaller than the outer diameter M of the shaft 7a before the press fitting. The inner diameter Wa1 of the tips 171a of the plural guide protrusions 171 of the guide protrusion group 271 is provided to be larger than the outer diameter M of the shaft 7a. Thus, after the shaft 7a is press fitted in the shaft press fit hole 71, a fixing force with which the press fit protrusion group 273 fixes or secures the shaft 7a can be assured. Even in a case where the shaft 7a becomes tilted or inclined relative to the Z direction while the shaft 7a is being inserted by press-fitting into the shaft press fit hole 71, the guide protrusions 171 come in contact with the shaft 7a and thus the shaft 7a can be returned to the predetermined place. Consequently, the shaft 7a is disposed accurately in the predetermined position of the shaft fit in hole 71 and is secured in the predetermined position with an appropriate fixing force.

In the embodiment, the press fitting load required when the shaft 7a is press fitted into the shaft press fit hole 71 can be reduced as described above, and thus heat generation by friction of the shaft 7a and the press fit protrusions 173 with each other can be reduced. Accordingly, welding (adhesion) of the shaft 7a and the press fit protrusions 173 with each other can be restricted. In addition, it can be restricted that foreign material is generated in association with the melt of part of the magnetic steel sheets 72, the dissolution which is attributed to the heat generated.

In the embodiment, the press fitting load with which the shaft 7a is press fitted and the fixing force with which the shaft 7a is fixed can be changed by changing a press-fit interference of the press fit protrusion 137, and thus the press fitting load and the fixing force can be adjusted easily.

In the embodiment, the plural steel sheets or plates can be machined or processed with a common die, thereby restricting increase in the number of the parts and components of the rotating electrical machine 1. Consequently, it can be restricted that a size of the rotating electrical machine 1 increases.

(Variations) The embodiment disclosed here is an example and is not intended to be limitative in all respects. The scope of the disclosure is indicated by the scope of claims but not by the explanation of the aforementioned embodiment. The scope of the disclosure includes the scope of claims and equivalents thereof, and all changes (variations) made within the scope.

For example, according to the example explained in the embodiment, from among the adjacent magnetic steel sheets 72, the press fit protrusions 173 of the magnetic steel sheet 721 arranged at the Z1 direction-side are stacked (rotationally stacked) to be shifted in the R direction by the predetermined angle θ (substantially 60 degrees, for example) relative to the guide protrusions 171 of the magnetic steel sheet 722 arranged at the Z2 direction-side, however, the disclosure is not limited thereto. For example, the predetermined angle of the shift in the R direction may be an arbitrary angle as far as the press fit protrusions of the magnetic steel sheet arranged at the Z1 direction-side are positioned at the Z1 direction-side relative to the guide protrusions of the magnetic steel sheet arranged at the Z2 direction-side.

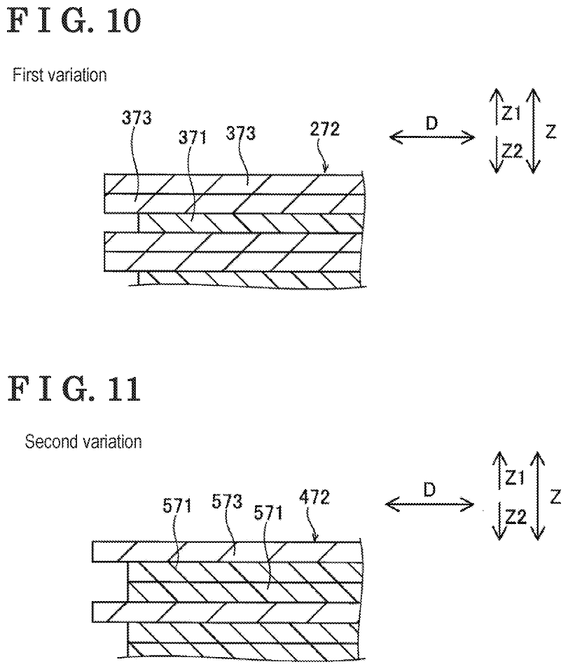

In the embodiment, the example is explained in which the press fit protrusion 173 and the guide protrusion 171 are arranged alternately with each other in the Z1 direction at the plural magnetic steel sheets 72, however, the disclosure is not limited thereto. In the disclosure, as in a first variation illustrated in FIG. 10, a press fit protrusion 373 and a guide protrusion 371 may overlap each other in the Z direction via another press fit protrusion 373 disposed between the said press fit protrusion 373 and the guide protrusion 371 in the Z direction, at plural magnetic steel sheets 272. As in a second variation illustrated in FIG. 11, a press fit protrusion 573 and a guide protrusion 571 may overlap each other in the Z direction via another guide protrusion 571 disposed between the press fit protrusion 573 and the said guide protrusion 571 in the Z direction, at plural magnetic steel sheets 472.

In the embodiment, the example is explained in which the press fit protrusion 173 includes the substantially trapezoid shape, wherein the width of the press fit protrusion 173 in the R direction gradually increases from the tip 173a towards the base (root) portion of the press fit protrusion 173, however the disclosure is not limited thereto. The press fit protrusion may include other shape than the substantially trapezoid shape, including, for example, an arc shape when viewed from the Z1 direction-side.

In the embodiment, the example is explained in which the guide protrusion 171 includes the substantially trapezoid shape, wherein the width of the guide protrusion 171 in the R direction gradually increases from the tip 171a of the guide protrusion 171 towards the base (root) portion of the guide protrusion 171, however the disclosure is not limited thereto. The guide protrusion may include other shape than the substantially trapezoid shape, including, for example, an arc shape when viewed from the Z1 direction-side.

In the embodiment, the example is explained in which each of the press fit protrusion groups 273 and each of the guide protrusion groups 271 are arranged to be point symmetric with each other with respect to the central point of the shaft 7a when viewed from the Z1 direction-side, however the disclosure is not limited thereto. For example, each of the press fit protrusion groups and the guide protrusion groups are arranged side by side with each other in the R direction, but do not need to be arranged to be point symmetric with each other with respect to the central point of the shaft when viewed from the Z1 direction-side.

In the embodiment, the example is explained in which the rotating electrical machine 1 is configured as, for example, the motor for the compressor or as the motor for the hydro booster, however, the disclosure is not limited thereto. For example, the rotating electrical machine may be configured as a motor of other type which is provided with a magnetic steel sheet and a shaft.

In the embodiment, the example is explained in which the plural (two, for example) press fit protrusions 173 that are adjacent to each other in the R direction serve as the press fit protrusion group 273, however, the disclosure is not limited thereto. In the disclosure, three or more than three press fit protrusions may correspond to the press fit protrusion group.

In the embodiment, the example is explained in which the plural (two, for example) guide protrusions 171 that are adjacent to each other in the R direction serve as the guide protrusion group 271, however, the disclosure is not limited thereto. In the disclosure, three or more than three guide protrusions may correspond to the guide protrusion group.

According to the aforementioned embodiment, a rotating electrical machine 1 includes a rotor 7, and a stator 6 provided to oppose the rotor 7 in a D direction. The rotor 7 includes a shaft 7a, and a rotor core 7c including a shaft press fit hole 71 in which the shaft 7a is configured to be press fitted and plural magnetic steel sheets 72, 272, 472, 721, 722 stacked in a Z direction (i.e., an axial direction) of the shaft 7a. Each of the plural magnetic steel sheets 72 includes plural press fit protrusions 173, 373, 573 provided at an inner circumferential portion 72a of the magnetic steel sheet 72, 272, 472, 721, 722 to protrude towards the shaft 7a. The plural press fit protrusions 173, 373, 573 are in contact with the shaft 7a press fitted in the shaft press fit hole 71. Each of the plural magnetic steel sheets 72 includes plural guide protrusions 171, 371, 571 provided at the inner circumferential portion 72a of the magnetic steel sheet 72 to protrude towards the shaft 7a with protruding amount which is smaller than protruding amount of the plural press fit protrusions 173, 373, 573. The plural guide protrusions 171, 371, 571 guide the shaft 7a being press fitted into the shaft press fit hole 71. The plural magnetic steel sheets 72 include the adjacent magnetic steel sheets 72 which are adjacent to each other in the Z direction of the shaft 7a, and the adjacent magnetic steel sheets 72 include the magnetic steel sheet 721 at a Z1 direction-side (i.e., a first side in the Z direction) and the magnetic steel sheet 722 at a Z2 direction-side (i.e., a second side in the Z direction). The plural magnetic steel sheets 72 are stacked to be shifted relative to each other in an R direction so that the press fit protrusions 173 of the magnetic steel sheet 721 at the Z1 direction-side and the guide protrusions 171 of the magnetic steel sheet 722 at the Z2 direction-side overlap each other in the Z direction.

According to the above described configuration, each of the plural magnetic steel sheets 72, 272, 472, 721, 722 is provided with the plural press fit protrusions 173, 373, 573 that are in contact with the shaft 7c press fitted in the shaft press fit hole 71, and the plural guide protrusions 171, 371, 571 guiding the shaft 7c that is being press fitted into the shaft press fit hole 71. The adjacent magnetic steel sheets 721, 722 are stacked to be shifted relative to each other in the R direction. Accordingly, in the Z direction, out of the adjacent magnetic steel sheets 721, 722, the press fit protrusions 173 of the magnetic steel sheet 721 at the Z1 direction-side and the guide protrusions 171 of the magnetic steel sheet 722 at the Z2 direction-side overlap each other. Consequently, the guide-side space S is provided at a portion at a side of the shaft 7a relative to the tip 171a of the guide protrusion 171 of the magnetic steel sheet 722 arranged at the Z2 direction-side. Here, in the Z1 direction, the guide-side space S is formed between the circumferential surface 17 of the shaft 7a and the portion of the press fit protrusion 173 of the magnetic steel sheet 721 at the Z1 direction-side, the portion which is at a side of the shaft 7a. Accordingly, since the guide-side space S is provided, the portion of the press fit protrusion 173 of the magnetic steel sheet 721 arranged at the Z1 direction-side, the portion which is at a side of the shaft 7a, is easily bent towards the Z2 direction-side due to the press fitting load generated when the shaft 7a is press fitted into the shaft press fit hole 71. That is, the press fitting load required to press fit the shaft 7a into the shaft press fit hole 71 can be reduced compared to a case in which the guide-side space S is not provided. The plural magnetic steel sheets 72 include in common the plural press fit protrusions 137 and the plural guide protrusions 171, thus the plural magnetic steel sheets 72 can be processed with a common press die. Accordingly, productivity of the rotating electrical machine 1 can be enhanced. As a result, both the reduction in the press fitting load to press fit the shaft 7a and the enhancement of the productivity of the rotating electrical machine 1 can be achieved. Even in a case where the shaft 7a is inclined or tilted during the press fitting work due to deviation or displacement of a jig used for press fitting the shaft 7a, the shaft 7a comes in contact with the guide protrusions 171, and thus the shaft 7a is returned to the predetermined position. Consequently, it is restricted that the press fitting load of the shaft 7a increases due to that the shaft 7a is press fitted in the state of being tilted, and an accuracy in placing the shaft 7a in the predetermined position of the shaft press fit hole 71 is enhanced. The plural magnetic steel sheets 72 are provided with the plural press fit protrusions 137 and the plural guide protrusions 171 in a common manner. Thus, one type of the magnetic steel sheets 72 can be utilized. Accordingly, the increase in types of the press dice can be restricted even though the press fit protrusions 173 and the guide protrusions 171 are formed at the magnetic steel sheet 72.

According to the aforementioned embodiment, at the plural magnetic steel sheets 72, 721, 722, each of the press fit protrusions 173 and each of the guide protrusions 171 are arranged to alternate with each other in the Z direction of the shaft 7a.

According to the above described configuration, the guide-side space S is arranged adjacent to the portion of each of the plural press fit protrusions 173 of the plural magnetic steel sheets 72, the portion which is positioned at a side of the shaft 7a. Thus, each of the plural press fit protrusions 173 becomes easy to bend towards the Z2 direction-side by the press fitting load. As result, in the Z direction, the press fitting load needed to press-fit the shaft 7a into the shaft press fit hole 71 can be even further reduced.

According to the aforementioned embodiment, the magnetic steel sheet 721 at the Z1 direction-side (i. e. the first side) and the magnetic steel sheet 722 at the Z2 direction-side (i.e., the second side) are stacked to be shifted relative to each other in the R direction so that a center line R1, in the R direction, of each of the press fit protrusions 173 of the magnetic steel sheet 721 at the Z1 direction-side and a center line R2, in the R direction, of each of the guide protrusions 171 of the magnetic steel sheet 722 at the Z2 direction-side are aligned with each other along the Z direction.

According to the above described configuration, the positional shift, in the R direction, of the guide-side space S and the press fit protrusions 173 of the magnetic steel sheet 721 at the Z1 direction-side relative to each other is restricted from occurring, and thus the press fit protrusions 173 of the magnetic steel sheets 72 are bent more reliably due to the press fitting load of the shaft 7a. As a result, the press fitting load required at the press-fitting of the shaft 7a into the shaft fit hole 71 can be reduced even more reliably.

According to the aforementioned embodiment, a press fit protrusion group 273 (i.e., a set of plural press fit protrusions) and a guide protrusion group 271 (i.e., a set of plural guide protrusions) are arranged to be adjacent to each other in the R direction.

According to the above described configuration, by providing the above-described configuration to each of the plural magnetic steel sheets 72, the advantageous effects are obtained that the press fitting load needed to press fit the shaft 7a into the shaft press fit hole 71 can be reduced more and that the variation or dispersion of the press fitting load of the shaft 7a can be restricted, compared to a case in which a single press fit protrusion and a single guide protrusion are arranged adjacent to each other in the R direction.

According to the aforementioned embodiment, an inner diameter Wb between tips 173a of the plural press fit protrusions 173 is provided to be smaller than an outer diameter M of the shaft 7a before the shaft 7a is press fitted, and an inner diameter Wa between tips 171a of the plurality of guide protrusions 171 is provided to be larger than the outer diameter M of the shaft 7a.

According to the above described configuration, after the shaft 7a has been press fitted in the shaft press fit hole 71, a fixing force with which the press fit protrusions 173 fix or secure the shaft 7a can be assured. Even in a case where the shaft 7a becomes tilted or inclined relative to the Z direction while the shaft 7a is being inserted by press-fitting into the shaft press fit hole 71, the guide protrusions 171 come in contact with the shaft 7a and thus the shaft 7a can be returned to the predetermined place. Consequently, the shaft 7a is disposed accurately in the predetermined position of the shaft fit in hole 71 and is secured in the predetermined position with an appropriate fixing force.

According to the aforementioned embodiment, a press fit protrusion group 273 and a guide protrusion group 271 are arranged to be point symmetric with each other with respect to a central point of the shaft 7a when viewed from the Z1 direction-side.

According to the above described configuration, the press fit protrusion group 273 and the guide protrusion group 271 oppose or face each other in a direction that is orthogonal to the Z direction. Accordingly, the positioning of the press fit protrusions 173 of the magnetic steel sheet 721 at the Z1 direction-side and the guide protrusions 171 of the magnetic steel sheet 722 at the Z2 direction-side can be performed easily when the magnetic steel sheet 721 at the Z1 direction-side and the magnetic steel sheet 722 at the Z2 direction-side are stacked to be shifted relative to each other in the R direction such that the press fit protrusion 173 of the magnetic steel sheet 721 at the Z1 direction-side and the guide protrusion 171 of the magnetic steel sheet 722 at the Z2 direction-side are overlapped each other in the Z direction.

According to the aforementioned embodiment, the press fit protrusion group 273 and the guide protrusion group 271 are arranged to be adjacent to each other at an equal angular interval θ along the inner circumferential portion 72a of the magnetic steel sheet 72.

According to the above described configuration, the press fit protrusion group 273 and the guide protrusion group 271 are arranged at the inner circumferential portion 72a of the magnetic steel sheet 72 in the R direction in a balanced manner. Thus, the shaft 7a can be fixed or secured with fixing forces by the press fit protrusion group 273 and can be guided to the predetermined position of the shaft press fit hole 71 by the guide protrusion group 271, wherein the fixing forces are substantially even or uniform with each other.

According to the aforementioned embodiment, each of the press fit protrusions 173, 373, 573 is formed to include a dimensional tolerance of interference fitting relative to the shaft 7a and each of the guide protrusions 171, 371, 571 is formed to include a dimensional tolerance of loose fitting relative to the shaft 7a.

According to the above described configuration, the press fit protrusions 173, 373, 573 and the shaft 7a are allowed to be in contact with each other reliably even in a case where the press fit protrusions 173, 373, 573 include the maximum dimensional tolerance. The guide protrusions 171, 371, 571 and the shaft 7a are restricted from being in contact with each other even in a case where the guide protrusions 171, 371, 571 include the maximum dimensional tolerance. As a result, the shaft 7a can be secured or fixed reliably by the press fit protrusions 173, 373, 585, and the press fitting load at the press fitting of the shaft 7a can be restricted from increasing due to the contact of the guide protrusions 171, 371, 571 and the shaft 7a with each other.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotating electrical machine comprising:
a rotor; and
a stator provided to oppose the rotor in a radial direction;
the rotor including:
a shaft; and
a rotor core including a shaft press fit hole in which the shaft is configured to be press fitted, and a plurality of magnetic steel sheets stacked in an axial direction of the shaft;
each of the plurality of magnetic steel sheets including:
a plurality of press fit protrusions provided at an inner circumferential portion of the magnetic steel sheet to protrude towards the shaft, the plurality of press fit protrusions being in contact with the shaft press fitted in the shaft press fit hole;
a plurality of guide protrusions provided at the inner circumferential portion of the magnetic steel sheet to protrude towards the shaft with protruding amount which is smaller than protruding amount of the plurality of press fit protrusions, the plurality of guide protrusions guiding the shaft being press fitted into the shaft press fit hole; and
the plurality of magnetic steel sheets including the adjacent magnetic steel sheets which are adjacent to each other in the axial direction of the shaft, the adjacent magnetic steel sheets including the magnetic steel sheet at a first side in the axial direction and the magnetic steel sheet at a second side in the axial direction, the plurality of magnetic steel sheets being stacked to be shifted relative to each other in a circumferential direction so that the press fit protrusions of the magnetic steel sheet at the first side and the guide protrusions of the magnetic steel sheet at the second side overlap each other in the axial direction.

2. The rotating electrical machine according to claim 1, wherein
at the plurality of magnetic steel sheets, each of the press fit protrusions and each of the guide protrusions are arranged to alternate with each other in the axial direction of the shaft.

3. The rotating electrical machine according to claim 1, wherein the magnetic steel sheet at the first side and the magnetic steel sheet at the second side are stacked to be shifted relative to each other in the circumferential direction so that a center line, in the circumferential direction, of each of the press fit protrusions of the magnetic steel sheet at the first side and a center line, in the circumferential direction, of each of the guide protrusions of the magnetic steel sheet at the second side are aligned with each other along the axial direction of the shaft.

4. The rotating electrical machine according to claim 1, wherein a set of plurality of press fit protrusions and a set of plurality of guide protrusions are arranged to be adjacent to each other in the circumferential direction.

5. The rotating electrical machine according to claim 1, wherein
an inner diameter between tips of the plurality of press fit protrusions is provided to be smaller than an outer diameter of the shaft before the shaft is press fitted, and
an inner diameter between tips of the plurality of guide protrusions is provided to be larger than the outer diameter of the shaft.

6. The rotating electrical machine according to claim 1, wherein a set of plurality of press fit protrusions and a set of plurality of guide protrusions are arranged to be point symmetric with each other with respect to a central point of the shaft when viewed from the first side in the axial direction of the shaft.

7. The rotating electrical machine according to claim 4, wherein the set of plurality of press fit protrusions and the set of plurality of guide protrusions are arranged to be adjacent to each other at an equal angular interval along the inner circumferential portion of the magnetic steel sheet.

8. The rotating electrical machine according to claim 1, wherein each of the press fit protrusions is formed to include a dimensional tolerance of interference fitting relative to the shaft and each of the guide protrusions is formed to include a dimensional tolerance of loose fitting relative to the shaft.
